(19) United States
(12) Patent Application Publication
(10) Pub. No.: US 2026/0337437 A1
(43) Pub. Date: Oct. 29, 2026

(54) TIRE FOR CONSTRUCTION VEHICLE

(71) Applicant: The Yokohama Rubber Co., LTD., Kanagawa (JP)

(72) Inventor: Ayako OZAKI, Kanagawa (JP)

(21) Appl. No.: 19/551,051

(22) Filed: Feb. 26, 2026

(30) Foreign Application Priority Data
Mar. 12, 2025 (JP) 2025-039714

(51) Int. Cl. C09D 107/00; B60C 1/00; B60C 9/00; B60C 9/18; C08K 3/04; C08K 3/36; C08K 5/548; C08K 5/55; C08K 13/02; C09D 7/61; C09D 7/63

(52) U.S. Cl. CPC C09D 107/00; B60C 1/00; B60C 9/18; C09D 7/61; C09D 7/63; B60C 2001/0066; B60C 9/0007; B60C 2009/1828; B60C 2200/065; C08K 3/04; C08K 3/36; C08K 5/548; C08K 5/55; C08K 13/02

(57) ABSTRACT

A tire includes a rubber for belt coating of a belt layer which contains a diene-based rubber including a natural rubber, a filler composed of carbon black and silica, and a cobalt salt, the filler being contained in an amount of from 40 to 65 parts by mass per 100 parts by mass of the diene-based rubber, the silica being contained in an amount of from 5 to 30 parts by mass per 100 parts by mass of the diene-based rubber, a content of the cobalt salt as an amount of cobalt being less than 0.1 pars by mass, the rubber for belt coating satisfying (EB (20 °C))/(E′ (20 °C))=60 to 95, the belt layer having a thickness of from 20 mm to 45 mm, and the metallic cord having a wire diameter of from 0.15 mm to 0.35 mm.

### CROSS-REFERENCE TO RELATED APPLICATION

This application claims priority pursuant to 35 U.S.C. 119(a) to Japan Patent Application No. 2025-039714, filed Mar. 12, 2025, the entire contents of which is incorporated herein by reference.

### FIELD OF THE INVENTION

The present technology relates to a tire for a construction vehicle and more specifically to a tire for a construction vehicle which suppresses heat generation of a belt layer and provides an improved adhesiveness between a metallic cord and a rubber for belt coating to have high durability and excellent processability.

### BACKGROUND

A pneumatic tire is mainly composed of a pair of left and right bead portions and sidewall portions, and a tread portion continuous with both sidewall portions. A carcass layer is provided on the inner side of the tire, and both end portions of the carcass layer are folded back from the tire inner side toward the tire outer side to wrap a bead core.

The tread portion is composed of a cap tread and an undertread, and a belt layer is disposed between the undertread and the carcass layer. Since a strong impact or a large load is applied to the belt layer, a metallic cord such as a steel cord is used as a reinforcing member, and the metallic cord is covered with a rubber for belt coating.

On the other hand, construction vehicles, such as large dump trucks operating at mines or large construction sites, operate for a long time while carrying a heavy load. A tire for a construction vehicle mounted on such a construction vehicle is required to avoid bursting or the like during operation in a mine, for example. Therefore, the tire for a construction vehicle is required to have high durability. To enhance the durability, it is effective to suppress heat generation when driving, particularly heat generation of a belt layer. Typically, to obtain a low heat generation property, there is a method for reducing the blended amount of carbon black, but this decreases a storage modulus (E′) and increases a strain of a rubber, which may cause a tire breakage. In such a way, the low heat generation property and the durability of a large tire are in a trade-off relationship.

For the purpose of providing a rubber composition that improves adhesion performance with a steel cord, Japan Patent No. 6288148 B describes a rubber composition obtained by blending from 0.3 to 1.5 parts by mass of cobalt boron neodecanoate, from 0.5 to 1.0 parts by mass of cobalt stearate, 0.5 or more and less than 2.0 parts by mass of a phenol-based resin, from 0.5 to 5.0 parts by mass of a curing agent, and from 4.0 to 8.0 parts by mass of sulfur per a diene-based rubber including a natural rubber, wherein a dynamic storage modulus (E′) at a dynamic strain of 2% and 20 °C is 13 MPa or more, a loss tangent (tan 8) at 60 °C is 0.20 or less, and the number of repetitions until breakage in a constant strain fatigue test at a strain of 60% and 400 rpm is 35,000 or more.

### SUMMARY

The present technology provides a tire for a construction vehicle which suppresses heat generation of a belt layer and provides an improved adhesiveness between a metallic cord and a rubber for belt coating to have high durability and excellent processability.

As a result of intensive studies, the present inventors have found that the above problems can be solved by specifying the composition of a rubber for belt coating, setting the ratio of the elongation at break to the dynamic storage modulus of the rubber for belt coating to a specific range, and setting the thickness of a belt layer and the wire diameter of a steel cord to specific ranges, and thus have completed the present technology.

In other words, the present technology provides a tire for a construction vehicle, the tire including a belt layer with a metallic cord coated with a rubber for belt coating, the rubber for belt coating containing a diene-based rubber including a natural rubber, a filler composed of carbon black and silica, and a cobalt salt, the filler being contained in an amount of from 40 to 65 parts by mass per 100 parts by mass of the diene-based rubber, the silica being contained in an amount of from 5 to 30 parts by mass per 100 parts by mass of the diene-based rubber, a content of the cobalt salt as an amount of cobalt being less than 0.1 parts by mass per 100 parts by mass of the diene-based rubber, an elongation at break at 20 °C (EB (20 °C)) and a dynamic storage modulus at 20 °C (E′ (20 °C)) of the rubber for belt coating satisfying Formula (1) below, the belt layer having a thickness of from 20 mm to 45 mm, and the metallic cord having a wire diameter of from 0.15 mm to 0.35 mm, (EB (20 °C))/(E′ (20 °C))=60 to 95 Formula (1).

According to the present technology, it is possible to provide a tire for a construction vehicle which suppresses heat generation of the belt layer and provides an improved adhesiveness between the metallic cord and the rubber for belt coating to have high durability and excellent processability.

### BRIEF DESCRIPTION OF DRAWINGS

FIG. 1 is a meridian half cross-sectional view illustrating a tire for a construction vehicle according to an embodiment of the present technology; and,

FIG. 2 is a cross-sectional view illustrating an example of a steel cord having an N× (1+M) structure to be used in an embodiment of the present technology.

### DETAILED DESCRIPTION

The present technology will be described in more detail below. First, a rubber for belt coating will be described below. The rubber for belt coating contains a diene-based rubber including a natural rubber, a filler composed of carbon black and silica, and a cobalt salt.

### Diene-Based Rubber

The diene-based rubber to be used for the rubber for belt coating includes a natural rubber (NR) as an essential component. From the perspective of providing improved effects of the present technology, the NR is contained in an amount of 80 parts by mass or more in 100 parts by mass of the diene-based rubber. Note that an isoprene rubber (IR) is included in NR to be used in the present technology.

Also, in the present technology, rubbers other than the NR rubber can be used for the diene-based rubber, and examples thereof include butadiene rubber (BR), styrene-butadiene copolymer rubber (SBR), acrylonitrile-butadiene copolymer rubber (NBR), and an ethylene-propylene-diene terpolymer (EPDM). These rubbers may be used alone, or two or more thereof may be used in combination. Furthermore, the molecular weight and the microstructure thereof are not particularly limited, and the diene-based rubber may be terminal-modified with an amine, amide, silyl, alkoxysilyl, carboxyl, or hydroxyl group or may be epoxidized.

The weight-average molecular weight (Mw) of the diene-based rubber is not particularly limited, but is preferably from 100000 to 5000000, more preferably from 200000 to 3000000, and still, more preferably, from 300000 to 2000000, for the reason of the superior effect of the present technology.

Note that the weight-average molecular weight (Mw) and the number-average molecular weight (Mn) as used in the present description are standard polystyrene equivalent values as determined by gel permeation chromatography (GPC) measurement.

### Filler

The filler to be used in the rubber for belt coating is composed of carbon black and silica. The nitrogen adsorption specific surface area (N₂SA) of the carbon black is preferably from 50 to 120 m²/g and more preferably from 60 to 100 m²/g, from the perspective of providing the improved effects of the present technology. Also, the CTAB (cetyltrimethylammonium bromide) specific surface area of the silica is preferably from 100 to 220 m²/g and more preferably from 130 to 190 m²/g, from the perspective of providing the improved effects of the present technology. The silica using a biomass material such as rice husks as a raw material may be used.

The content ratio of the silica to the carbon black is preferably from 0.05 to 0.5 and more preferably from 0.10 to 0.3 as the mass ratio of silica/carbon black.

Note that the nitrogen adsorption specific surface area (N₂SA) in the present technology is a value measured in accordance with JIS (Japanese Industrial Standard) K6217-2:2001 “Part 2: Determination of specific surface area—Nitrogen adsorption methods—Single-point procedures” and the CTAB specific surface area is the amount of n-hexadecyltrimethylammonium bromide adsorbed onto a surface of silica measured in accordance with JIS K6217-3:2001 “Part 3: Determination of specific surface area—CTAB adsorption methods”.

### Cobalt Salt

Examples of the cobalt salt to be used in the rubber for belt coating include organic acid cobalt salts such as cobalt naphthenate, cobalt neodecanoate, cobalt stearate, cobalt rosinate, cobalt versatate, cobalt tallate, cobalt borate neodecanoate, and cobalt acetylacetonate.

### Silane Coupling Agent

The rubber for belt coating in the present technology preferably contains a silane coupling agent. The silane coupling agent to be used may be any silane coupling agent that can be used in a rubber composition blended with silica, and among them, a sulfur-containing silane coupling agent is preferable. Specific examples of such sulfur-containing silane coupling agents include bis-(3-triethoxysilylpropyl)tetrasulfide, bis(3-triethoxysilylpropyl)disulfide, 3-trimethoxysilylpropylbenzothiazol tetrasulfide, Y-mercaptopropyltriethoxysilane, and 3-octanoylthiopropyltriethoxysilane.

### Blended Proportion of Rubber for Belt Coating

The rubber for belt coating contains a diene-based rubber including a natural rubber, a filler composed of carbon black and silica, and cobalt salt, the filler being contained in an amount of from 40 to 65 parts by mass per 100 parts by mass of the diene-based rubber, the silica being contained in an amount of from 5 to 30 parts by mass per 100 parts by mass of the diene-based rubber, and a content of the cobalt salt as an amount of cobalt being less than 0.1 parts by mass per 100 parts by mass of the diene-based rubber.

In a case where the content of the filler is less than 40 parts by mass, the adhesiveness between the metallic cord and the rubber for belt coating, durability, and processability are deteriorated, and in a case where the content of the filler exceeds 65 parts by mass, the durability, heat generation property, and processability are deteriorated.

In a case where the content of the silica is less than 5 parts by mass, the adhesiveness between the metallic cord and the rubber for belt coating, durability, and heat generation property are deteriorated, and in a case where the content of the silica exceeds 30 parts by mass, the adhesiveness between the metallic cord and the rubber for belt coating, durability, and processability are deteriorated.

In a case where the amount of cobalt is 0.1 parts by mass or more, the adhesiveness between the metallic cord and the rubber for belt coating, durability, and heat generation property are deteriorated, and in a case without cobalt, the adhesiveness between the metallic cord and the rubber for belt coating, durability, and heat generation property are deteriorated.

From the perspective of providing the improved effects of the present technology, the content of the filler is preferably from 43 to 60 parts by mass per 100 parts by mass of the diene-based rubber.

From the perspective of providing the improved effects of the present technology, the content of the silica is preferably from 6 to 25 parts by mass per 100 parts by mass of the diene-based rubber. The blended amount of the silane coupling agent is preferably from 0.1 to 3 parts by mass per 100 parts by mass of the silica.

From the perspective of providing the improved effects of the present technology, the content of the cobalt as the amount of cobalt is preferably from 0.001 to 0.09 parts by mass per 100 parts by mass of the diene-based rubber. Also, in the filler described above, the content of the carbon black is preferably from 35 to 60 parts by mass per 100 parts by mass of the diene-based rubber.

Note that in addition to the components described above, various additives commonly blended in the rubber for belt coating, such as a vulcanizing or crosslinking agent; a vulcanization or crosslinking accelerator; zinc oxide; an anti-aging agent; a plasticizer, and various fillers, can be blended, and these additives may be kneaded by a commonly used method to form a composition, which can be used to undergo a vulcanization or crosslinking reaction. The blended amount of these additives may also be a known common blended amount, as long as the present technology is not impaired.

In the tire for a construction vehicle according to the present technology, the elongation at break at 20 °C (EB (20 °C)) and the dynamic storage modulus at 20 °C (E′ (20 °C)) of the rubber for belt coating may satisfy Formula (1) below and preferably satisfy Formula (11) below. In case of not satisfying the condition of Formula (1) below, the present technology cannot be effective.

(EB(20 °C))/(E′(20 °C))=60 to 95 Formula (1)

(EB(20 °C))/(E′(20 °C))=63 to 93. Formula (11)

The dynamic storage modulus (E′) is a value (MPa) measured in accordance with JIS K6394 using a viscoelastic spectrometer available from Toyo Seiki Seisaku-sho, Ltd. under the conditions of a static distortion of 10%, dynamic distortion of ±2%, a frequency of 20 Hz, and 20 °C.

Also, the elongation at break (EB) is the value (MPa) measured in accordance with JIS K6251 in a tensile test under the condition of 20 °C.

Also, the elongation at break at 20 °C (EB (20 °C)) of the rubber for belt coating is preferably 150% or more, and the dynamic storage modulus at 20 °C (E′ (20 °C)) is preferably 3.5 MPa or more. The elongation at break (EB (20 °C)) is preferably 700% or less, and the dynamic storage modulus (E′ (20 °C)) is preferably 20 MPa or less.

The values of the elongation at break (EB) and the dynamic storage modulus (E′) can be adjusted by changing the amount of the filler, the type of filler, the amount of vulcanization accelerator, the amount of sulfur, and the like. From this perspective, the content of the vulcanization accelerator in the rubber for belt coating is preferably from 0.1 to 5.0 parts by mass per 100 parts by mass of the diene-based rubber, and the content of sulfur is preferably from 2.0 to 10.0 parts by mass per 100 parts by mass of the diene-based rubber.

The belt layer in the tire for a construction vehicle according to the present technology is formed by embedding a metallic cord in the rubber for belt coating. An example of the metallic cords includes a steel wire, and a steel wire coated with a plating compound is preferable. Examples of the plating compound include brass plating, copper-tin plating, copper plating, zinc plating, nickel plating, chromium plating, and copper-zinc-cobalt ternary plating.

The belt layer in the tire for a construction vehicle according to the present technology can be obtained by, for example, mixing the various components described above in a general-purpose mixer such as a Banbury Mixer or a roll mixer to prepare a rubber for belt coating, embedding the metallic cord therein followed by for example, vulcanization thereof according to a conventional method. Note that in mixing them using the mixer described above, the mixing temperature is preferably set to 150 °C or higher and 170 °C or lower. Under this mixing temperature condition, a molecular chain of the natural rubber is inhibited from being cut, and the reaction efficiency of the silane coupling agent is enhanced, so that the present technology can be more satisfactorily effective.

In addition, a method of producing the tire for a construction vehicle according to the present technology is not particularly limited, and the tire for a construction vehicle can be produced by a known technique. The tire for a construction vehicle is preferably a pneumatic tire, which can be filled with any gas including air and inert gas such as nitrogen.

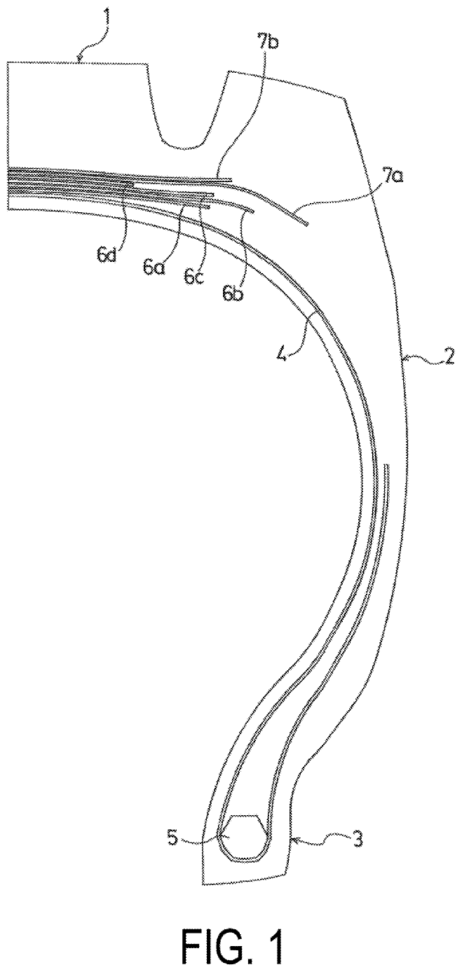

FIG. 1 is a meridian half cross-sectional view illustrating a tire for a construction vehicle according to an embodiment of the present technology.

In FIG. 1, 1 denotes a tread portion; 2 denotes a sidewall portion; and 3 is a bead portion. A carcass layer 4 including a plurality of reinforcing cords extending in the tire radial direction is mounted between a pair of the left and right bead portions 3, 3, and the end portion of the carcass layer 4 is folded back around a bead core 5 from the tire inner side to the tire outer side. The tread portion 1 usually has a cap tread portion and an undertread portion in order from the tire surface side (not illustrated). Note that, from the perspective of providing the improved effects of the present technology, a thickness of the undertread is preferably from 15 mm to 50 mm.

A plurality of belt layers 6a, 6b, 6c, 6d are embedded on an outer circumferential side of the carcass layer 4 in the tread portion 1. The belt layers 6a to 6d include a plurality of metallic cords inclined with respect to the tire circumferential direction, which are covered with the rubber for belt coating. In the belt layers 6a to 6d, a thickness of the belt layer (in a direction orthogonal to a tire rotation axis) is preferably from 20 mm to 45 mm. Note that the thickness of the belt layer is a total value of the thicknesses of all the belt layers. Also, in the belt layers 6a to 6d, the inclination angle of the metallic cord with respect to the tire circumferential direction is set to fall in the range from, for example, 15° to 40°, and the code density is set to fall within the range from, for example, 10 cords/50 mm to 25 cords/50 mm. A steel cord is used as the metallic cord for the belt layers 6a to 6d. Note that in FIG. 1, the belt layer is composed of four layers, but the present technology is not limited thereto, and the belt layer is preferably composed of the range from three layers to eight layers. Furthermore, on an outer circumferential side of the belt layers 6a to 6d, a plurality of belt protecting layers 7a, 7b are embedded. While the belt layers 6a to 6d support the tread portion 1 to reinforce it, the belt protecting layers 7a, 7b are disposed to protect the belt layers 6a to 6d.

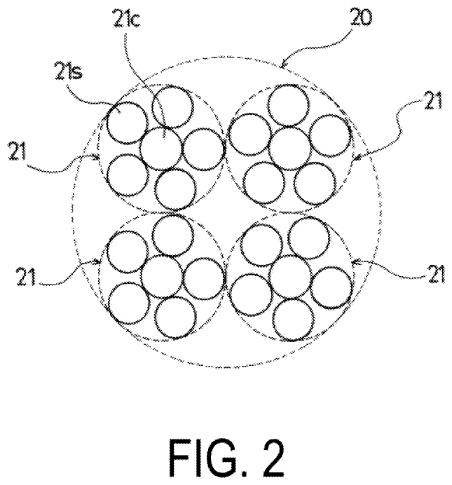

Then, the metallic cord that is a steel cord having an N× (1+M) structure described below is used as an embodiment. FIG. 2 illustrates an example of the steel cord having an N× (1+M) structure to be used in an embodiment of the present technology. As illustrated in FIG. 2, a steel cord 20 has an N× (1+M) structure in which N (N=3 to 5) strands 21 composed of one core filament 21c and M (M=4 to 6) sheath filaments 21s are intertwined. In the present embodiment, the steel cord 20 has four strands 21, and each strand 21 is composed of one core filament 21c and five sheath filaments 21s. In other words, the structure is a 4×(1+5) structure. Other examples thereof include a 3×(1+4) structure, a 3×(1+5) structure, a 4×(1+4) structure, a 5×(1+4) structure, and a 5×(1+5) structure.

Note that the wire diameter of the metallic cord (for example, the core filament 21c and/or the sheath filament 21s) is preferably from 0.15 mm to 0.35 mm. When the wire diameter falls outside this range, its durability is deteriorated.

### EXAMPLES

The present technology will be described below in more detail by way of Examples and Comparative Examples, but the present technology is not limited to these Examples.

### Standard Example 1, Examples 1 to 4, and Comparative Examples 1 to 10

### Preparation of Sample

In the blended proportion (parts by mass) shown in Tables 1 and 2, the components other than the vulcanization-based components (vulcanization accelerator and sulfur) were mixed for 5 minutes in a Banbury mixer at 80 °C. The ultimate temperature at that time was 150 °C. Next, the vulcanization-based component was added and mixed by using a roll mill to obtain an unvulcanized rubber composition. Also, the unvulcanized rubber composition obtained was press-vulcanized at 170 °C for 10 minutes in a mold (15 cm×15 cm×0.2 cm) to fabricate a vulcanized rubber test piece. The following evaluations were performed using the unvulcanized rubber composition or the vulcanized rubber test piece.

Elongation at break (EB): The obtained vulcanized rubber test piece was used and measured by a tensile test under the condition of 20 °C in accordance with JIS K6251.

Dynamic storage modulus (E′): The resulting vulcanized rubber test piece was measured under the conditions of a static distortion of 10%, a dynamic distortion of ±2%, and a frequency of 20 Hz, and a temperature of 20 °C, using a viscoelastic spectrometer available from Toyo Seiki Seisaku-sho, Ltd. in accordance with JIS K6394.

Further, the ratio (EB (20 °C))/(E′ (20 °C)) was determined.

### Tire Durability

A steel wire was impregnated with the unvulcanized rubber composition obtained to be used as a belt layer, and then a pneumatic tire for a construction vehicle (size: 2700R49 inch) therewith was subjected to vulcanization molding. The vulcanization conditions were those of 150 °C for 43 minutes. Note that the belt layer had a 3+9×0.25+8×7×0.22+0.175 HT structure, and the total thicknesses of the belt layers in the tire radial direction and the wire diameters of the steel wires were shown in Tables 1 and 2. The obtained pneumatic tire for a construction vehicle was mounted on a JATMA standard rim, and after a vehicle with the tire was run in a mine for 3,000 hours, the number of cracks in the edge portion of the belt layer was measured, and the reciprocal thereof was determined. The result was shown as an index value with the value of Standard Example being taken as 100. The larger the index values, the less the number of cracks in the edge portion of the belt layer, indicating that the tire is excellent in its durability.

### Tire Heat Generation Property

The pneumatic tire for a construction vehicle fabricated in the test of “Tire Durability” was mounted on a JATMA standard rim, a load of 85% of the maximum load capacity was applied thereto, and a running test was performed with a drum testing machine (diameter of 5 m) under the condition of an air pressure of 700 kPa. A 24-hour indoor drum test was performed at a test speed of 10 km/h, and a temperature of the tread portion was measured. The result was shown as an index value with the value of Standard Example being taken as 100. A smaller index value indicates that the tire has a low heat generation property.

### Processability

The unvulcanized belt layer fabricated in the test of “Tire Durability” underwent a rolling process using a Stellar roll to set a thickness of the belt layer to 4 mm, and the resulting rolled member (sheet) was visually observed and evaluated on the basis of the following criteria:
Good: Favorable sheet texture
Fair: Poor sheet texture
Poor: Poor sheet texture. The steel wire is seen in places.

### Peel Strength:

In accordance with American Society for Testing and Materials D2229-24, the steel wire was pulled out from the vulcanized belt layer, which was fabricated in the test of “Tire Durability”, and pull out strength upon pull out was examined under an environmental temperature of 20 °C or 50 °C. The result was shown as an index value with the value of Standard Example being taken as 100. A larger value can be determined to result in an excellent adhesiveness between the steel wire and the rubber for belt coating.

The results are shown in Tables 1 and 2.

TABLE 1

| | Standard | Example | Example | Example | Example |
|---|---|---|---|---|---|
| | example | 1 | 2 | 3 | 4 |
| NR *1 | 100 | 100 | 100 | 100 | 100 |
| CB *2 | 50 | 40 | 35 | 40 | 40 |
| Silica *3 | — | 10 | 15 | 5 | 10 |
| Silane coupling agent 1 *4 | — | 0.5 | 0.75 | 0.25 | — |
| Silane coupling agent 2 *5 | — | — | — | — | 0.5 |
| Anti-aging agent *6 | 2 | 2 | 2 | 2 | 2 |
| Cobalt salt *7 | 0.05 | 0.05 | 0.05 | 0.05 | 0.05 |
| Stearic acid *8 | 1 | 1 | 1 | 1 | 1 |
| Zinc oxide *9 | 10 | 10 | 10 | 10 | 10 |
| Vulcanization | 1 | 1 | 1 | 1 | 1 |
| accelerator *10 | | | | | |
| Sulfur *11 | 8 | 8 | 8 | 8 | 8 |
| CB + silica amount (parts | 50 | 50 | 50 | 45 | 50 |
| by mass) | | | | | |
| (EB (20 °C))/(E′ (20 °C)) | 50 | 70 | 80 | 83 | 72 |
| Total thickness of belt | 20 | 20 | 20 | 20 | 20 |
| layers (mm) | | | | | |
| Wire diameter of metallic | 0.2 | 0.2 | 0.2 | 0.2 | 0.2 |
| cord (mm) | | | | | |
| Measurement results | | | | | |
| Tire durability | 100 | 120 | 127 | 114 | 123 |
| Tire heat generation | 100 | 90 | 85 | 97 | 91 |
| property | | | | | |
| Processability | Good | Good | Good | Good | Good |
| Peel strength (20 °C) | 100 | 115 | 115 | 113 | 118 |
| Peel strength (50 °C) | 100 | 120 | 126 | 117 | 124 |

TABLE 2-1

| | Standard | Comparative | Comparative | Comparative | Comparative | Comparative |
|---|---|---|---|---|---|---|
| | example | example 1 | example 2 | example 3 | example 4 | example 5 |
| NR *1 | 100 | 100 | 100 | 100 | 100 | 100 |
| CB *2 | 50 | 25 | 70 | 63 | 5 | 40 |
| Silica *3 | — | 10 | 10 | 2 | 40 | 10 |
| Silane coupling | — | 0.5 | 0.5 | 0.1 | 2.0 | 0.5 |
| agent 1 *4 | | | | | | |
| Silane coupling | — | — | — | — | — | — |
| agent 2 *5 | | | | | | |
| Anti-aging | 2 | 2 | 2 | 2 | 2 | 2 |
| agent *6 | | | | | | |
| Cobalt salt *7 | 0.05 | 0.05 | 0.05 | 0.05 | 0.05 | — |
| Stearic acid *8 | 1 | 1 | 1 | 1 | 1 | 1 |
| Zinc oxide *9 | 10 | 10 | 10 | 10 | 10 | 10 |
| Vulcanization | 1 | 1 | 1 | 1 | 1 | 1 |
| accelerator *10 | | | | | | |
| Sulfur *11 | 8 | 8 | 8 | 8 | 8 | 8 |
| CB + silica | 50 | 35 | 80 | 65 | 45 | 50 |
| amount (parts by | | | | | | |
| mass) | | | | | | |
| (EB (20 °C))/(E′ | 50 | 170 | 40 | 50 | 110 | 80 |
| (20 °C)) | | | | | | |
| Total thickness | 20 | 20 | 20 | 20 | 20 | 20 |
| of belt layers | | | | | | |
| (mm) | | | | | | |
| Wire diameter of | 0.2 | 0.2 | 0.2 | 0.2 | 0.2 | 0.2 |
| metallic cord | | | | | | |
| (mm) | | | | | | |
| Measurement | | | | | | |
| results | | | | | | |
| Tire durability | 100 | 82 | 90 | 94 | 72 | 60 |
| Tire heat | 100 | 81 | 133 | 106 | 83 | 101 |
| generation | | | | | | |
| property | | | | | | |
| Processability | Good | Fair | Poor | Good | Poor | Good |
| Peel strength | 100 | 83 | 102 | 95 | 82 | 20 |
| (20 °C) | | | | | | |
| Peel strength | 100 | 76 | 103 | 98 | 79 | 20 |
| (50 °C) | | | | | | |

TABLE 2-2

| | Comparative | Comparative | Comparative | Comparative | Comparative |
|---|---|---|---|---|---|
| | example 6 | example 7 | example 8 | example 9 | example 10 |
| NR *1 | 100 | 100 | 100 | 100 | 100 |
| CB *2 | 40 | 40 | 40 | 40 | 40 |
| Silica *3 | 10 | 10 | 10 | 10 | 10 |
| Silane coupling | 0.5 | 0.5 | 0.5 | 0.5 | 0.5 |
| agent 1 *4 | | | | | |
| Silane coupling | — | — | — | — | — |
| agent 2 *5 | | | | | |
| Anti-aging agent *6 | 2 | 2 | 2 | 2 | 2 |
| Cobalt salt *7 | 0.50 | 0.05 | 0.05 | 0.05 | 0.05 |
| Stearic acid *8 | 1 | 1 | 1 | 1 | 1 |
| Zinc oxide *9 | 10 | 10 | 10 | 10 | 10 |
| Vulcanization | 1 | 1 | 1 | 1 | 1 |
| accelerator *10 | | | | | |
| Sulfur *11 | 8 | 8 | 8 | 8 | 8 |
| CB + silica amount | 50 | 50 | 50 | 50 | 50 |
| (parts by mass) | | | | | |
| (EB (20 °C))/(E′ (20 °C)) | 80 | 70 | 70 | 70 | 70 |
| Total thickness of belt | 20 | 60 | 10 | 20 | 45 |
| layers (mm) | | | | | |
| Wire diameter of metallic | 0.2 | 0.2 | 0.2 | 0.08 | 0.45 |
| cord (mm) | | | | | |
| Measurement results | | | | | |
| Tire durability | 82 | 70 | 80 | 83 | 87 |
| Tire heat generation | 110 | 140 | 90 | 110 | 105 |
| property | | | | | |
| Processability | Good | Good | Good | Good | Good |
| Peel strength (20 °C) | 91 | 90 | 101 | 100 | 97 |
| Peel strength (50 °C) | 93 | 85 | 102 | 99 | 98 |

*1: NR (STR20)
*2: Carbon black (Show Black N326, nitrogen adsorption specific surface area (N₂SA) = 82 m²/g), available from Cabot Japan K.K.)
*3: Silica (ULTRASIL VN3GR, nitrogen adsorption specific surface area (N₂SA) = 180 m²/g, CTAB specific surface area = 150 m²/g, available from Evonik Industries AG)
*4: Silane coupling agent 1 (Si69, bis(3-triethoxysilylpropyl)tetrasulfide, available from Evonik Degussa Corporation)
*5: Silane coupling agent 2 (Si75, bis(3-triethoxysilylpropyl)disulfide, available from Evonik Degussa Corporation)
*6: Anti-aging agent (SANTOFLEX 6PPD, available from Flexsys)
*7: Cobalt salt (NBC-2, cobalt boron neodecanoate available from DIC Corporation; and in the table, the amount of cobalt is shown.)
*8: Stearic acid (Stearic acid YR, available from NOF Corporation)
*9: Zinc oxide (Zinc Oxide III, available from Seido Chemical Industry Co., Ltd.)
*10: Vulcanization accelerator (NOCCELER DZ, available from Ouchi Shinko Chemical Industrial Co., Ltd.)
*11: Sulfur (MUCRON OT-20, available from Shikoku Chemicals Corporation)

As can be seen from Tables 1 and 2, each of the Examples may be the tire for a construction vehicle, the tire including the belt layer with a metallic cord coated with a rubber for belt coating, the rubber for belt coating containing a diene-based rubber including a natural rubber, a filler composed of carbon black and silica, and a cobalt salt, the filler being contained in an amount of from 40 to 65 parts by mass per 100 parts by mass of the diene-based rubber, the silica being contained in an amount of from 5 to 30 parts by mass per 100 parts by mass of the diene-based rubber, a content of the cobalt salt as an amount of cobalt being less than 0.1 parts by mass per 100 parts by mass of the diene-based rubber, an elongation at break at 20 °C (EB (20 °C)) and a dynamic storage modulus at 20 °C (E′ (20 °C)) of the rubber for belt coating satisfying Formula (1) above, the belt layer having a thickness of from 20 mm to 45 mm, and the metallic cord having the wire diameter of from 0.15 mm to 0.35 mm, and therefore, it is understood that the tire for a construction vehicle can be provided which suppresses the heat generation of the belt layer as well as improves the adhesiveness between the metallic cord and the rubber for belt coating to have the higher durability and more excellent processability than Standard Example. Comparative Example 1 revealed, on the other hand, that the content of the filler composed of carbon black and silica was less than the lower limit specified in the present technology, and the value of Formula (1) above exceeded the upper limit specified in the present technology, resulting in the poor tire durability, poor processability and poor peel strength.

Comparative Example 2 revealed that the content of the filler composed of carbon black and silica exceeded the upper limit specified in the present technology, and the value of Formula (1) above was less than the lower limit specified in the present technology, resulting in the poor tire durability, high tire heat generation and poor processability.

Comparative Example 3 revealed that the content of silica was less than the lower limit specified in the present technology, and the value of Formula (1) above was less than the lower limit specified in the present technology, resulting in poor tire durability, high tire heat generation, and poor peel strength.

Comparative Example 4 revealed that the content of silica exceeded the upper limit specified in the present technology, and the value of Formula (1) above exceeded the upper limit specified in the present technology, resulting in the poor tire durability, poor processability, and poor peel strength.

In Comparative Example 5, the rubber for belt coating does not contain the cobalt salt, resulting in the poor tire durability and poor peel strength.

Comparative Example 6 revealed that the content of the cobalt salt exceeded the upper limit specified in the present technology, resulting in the poor tire durability, high tire heat generation, and poor peel strength.

In Comparative Example 7, the thickness of the belt layer exceeded the upper limit specified in the present technology, resulting in the poor tire durability, high tire heat generation, and poor peel strength.

In Comparative Example 8, the thickness of the belt layer was less than the lower limit specified in the present technology, resulting in the poor tire durability.

In Comparative Example 9, the wire diameter of the metallic cord was less than the lower limit specified in the present technology, resulting in the poor tire durability and high tire heat generation.

In Comparative Example 10, the wire diameter of the metallic cord exceeded the upper limit specified in the present technology, resulting in the poor tire durability, high tire heat generation, and poor peel strength.

The present technology includes the following embodiments.

### First Embodiment

A tire for a construction vehicle, the tire including a belt layer with a metallic cord coated with a rubber for belt coating, the rubber for belt coating containing a diene-based rubber including a natural rubber, a filler composed of carbon black and silica, and a cobalt salt, the filler being contained in an amount of from 40 to 65 parts by mass per 100 parts by mass of the diene-based rubber, the silica being contained in an amount of from 5 to 30 parts by mass per 100 parts by mass of the diene-based rubber, a content of the cobalt salt as an amount of cobalt being less than 0.1 parts by mass per 100 parts by mass of the diene-based rubber, an elongation at break at 20 °C (EB (20 °C)) and a dynamic storage modulus at 20 °C (E′ (20 °C)) of the rubber for belt coating satisfying Formula (1) below, the belt layer having a thickness of from 20 mm to 45 mm, and the metallic cord having a wire diameter of from 0.15 mm to 0.35 mm, (EB (20 °C))/(E′ (20 °C))=60 to 95 Formula (1).

### Second Embodiment

The tire for a construction vehicle according to the first embodiment, wherein an undertread of the tire for a construction vehicle has a thickness of from 15 mm to 50 mm.

### Third Embodiment

The tire for a construction vehicle according to the first embodiment or second embodiment, wherein the rubber for belt coating further contains a silane coupling agent.

### Fourth Embodiment

The tire for a construction vehicle according to any one of the first embodiments to third embodiment, wherein the silane coupling agent is a compound including two sulfur atoms in a molecule.

1. A tire for a construction vehicle, the tire comprising:
a belt layer with a metallic cord coated with a rubber for belt coating, the rubber for belt coating containing a diene-based rubber comprising a natural rubber, a filler composed of carbon black and silica, and a cobalt salt, the filler being contained in an amount of from 40 to 65 parts by mass per 100 parts by mass of the diene-based rubber, the silica being contained in an amount of from 5 to 30 parts by mass per 100 parts by mass of the diene-based rubber, a content of the cobalt salt as an amount of cobalt being less than 0.1 parts by mass per 100 parts by mass of the diene-based rubber, an elongation at break at 20 °C (EB (20 °C)) and a dynamic storage modulus at 20 °C (E′ (20 °C)) of the rubber for belt coating satisfying Formula (1) below, the belt layer having a thickness of from 20 mm to 45 mm, and the metallic cord having a wire diameter of from 0.15 mm to 0.35 mm, (EB (20 °C))/(E′ (20 °C))=60 to 95 Formula (1).

2. The tire for a construction vehicle according to claim 1, wherein an undertread of the tire for a construction vehicle has a thickness of from 15 mm to 50 mm.

3. The tire for a construction vehicle according to claim 1, wherein the rubber for belt coating further contains a silane coupling agent.

4. The tire for a construction vehicle according to claim 1, wherein the silane coupling agent is a compound comprising two sulfur atoms in a molecule.
